(19) United States
(12) Patent Application Publication
(10) Pub. No.: US 2005/0012237 A1
(43) Pub. Date: Jan. 20, 2005

(54) Apparatus and method for making pressed/cut articles

(76) Inventors: Kiyonori Koyama, Yamagata (JP); Tetsuya Makino, Tokyo (JP)

Correspondence Address: 3M INNOVATIVE PROPERTIES COMPANY, PO BOX 33427, ST. PAUL, MN, 55133-3427, US

(21) Appl. No.: 10/894,462

(22) Filed: Jul. 19, 2004

(30) Foreign Application Priority Data
Jul. 18, 2003 (JP) 2003-199285

(51) Int. Cl. B29C 43/02

(52) U.S. Cl. 264/161; 264/320; 425/395

(57) ABSTRACT

An apparatus for making pressed nonwoven articles, which apparatus has first and second die members that are arranged to move towards each other. The first die has a support surface for supporting a blank material, and the second die has a press surface for pressing the blank material. The pressing step occurs when the two dies are disposed in an operation position. The support surface has a support surface material that has a first hardness, and the press surface has a press surface material that has a second hardness. The first and second hardnesses are different from each other. The apparatus and method of the invention enable blank articles to pressed and/or cut as intended without risk of having unpressed or uncut portions.

This application claims priority from Japanese Application Number 2003-199285 filed on Jul. 18, 2003.

The present invention relates to an apparatus and a method for forming a blank material such as a nonwoven fabric used as an acoustic thermal insulation material in, for example, a motor vehicle, an airplane, a train, or the like.

### BACKGROUND

Acoustical insulation is commonly used in the transportation industry to reduce noise in, for example, passenger compartments. The insulation can come in a variety of forms, including felts, foams, compressed fibers, glass powder or “rock wool,” and recycled fabrics that have been hammer milled, resinated, and thermoset (shoddy materials). A recently developed product that exhibits extraordinary sound attenuation abilities is described in U.S. Pat. No. Re 36,323 to Thompson et al. This product uses a nonwoven web of thermoplastic fibers that have an average effective fiber diameter of less than about 15 micrometers. The nonwoven web has a thickness of less than about 0.5 centimeters, a density of less than about 50 kilograms per cubic meter, and a pressure drop of at least 1 millimeter water at a flow rate of 32 liters per minute. This product can be used as laminate where the nonwoven web is laminated to another layer such as a scrim, nonwoven fabric, film, or foil. Another example of a good performing acoustical insulation product is shown in U.S. Pat. No. 5,841,081 to Thompson et al. This product contains organic microfibers and 15 weight percent or greater heat activatable staple fibers. The acoustical insulation can be molded into a variety of shapes while retaining exceptional sound attenuation properties. Acoustical insulation materials of this kind are available from the 3M Company, St. Paul, Minn. under the trademark Thinsulate™.

Acoustical insulation products are regularly formed or punched into a predetermined shape so that they can be properly fitted for their intended use in, for example, a motor vehicle or household appliance. This forming and punching process is commonly referred to as “converting.” To convert a nonwoven web into an acoustical article, a general press machine can be used, which machine may be provided with a lower plate that has a metal support bed on which a nonwoven fabric is placed. The machine also may have an upper plate that has a cutting die for punching the nonwoven fabric. The cutting die may include a blade (so-called Thomson blade) that extends from a plate-like base, corresponding to a predetermined cutting shape of the nonwoven fabric.

Partially pressed portions are sometimes made in the nonwoven acoustical fabric to increase product strength, to reduce the risk of fraying, and to improve product handling and fit into the desired location. Japanese Unexamined Patent Publication (Kokai) No. 6-259081, for example, discloses a method for providing a reduced thickness region on the periphery of a formed acoustic insulation material by press-forming with a heated die to make handling easier during assembly.

If an acoustic insulation material is made of inorganic fibers such as glass fibers, in order to prevent the peripheral edge from becoming hard and sharp, thus leading to difficulty in handling, a thin portion may be left at the peripheral edge, using a die and a spacer, before punching the acoustic insulation material. See Japanese Unexamined Patent Publication (Kokai) No. 7-145545.

### SUMMARY OF THE INVENTION

The present invention provides a new apparatus for making pressed nonwoven articles. The new apparatus comprises first and second die members that are arranged to move towards each other, the first die having a support surface for supporting a blank material, and the second die having a press surface for pressing the blank material when the two dies are disposed in an operation position; the support surface comprising a support surface material that has a first hardness, and the press surface comprising a press surface material that has a second hardness, the first and second hardnesses being different from each other.

The present invention also provides a new method of making an acoustical insulation. The method comprises providing a support surface having a first hardness, and a press surface having a second hardness, the second hardness being different from the first hardness; placing a blank material between the support surface and the press surface; and pressing the blank material between the support surface and the press surface by moving the support surface and the press surface towards each other such that at least one of the support surface is capable of equalizing a gap therebetween.

In previously known manufacturing methods, in order to provide the pressed or reduced thickness (or thin) portion, a cutting operation typically has been performed in addition to the forming or punching of the nonwoven fabric. This additional step has increased the number of manufacturing steps, leading to a lower operational efficiency and an increased cost. Of course, a method where the cutting and the formation steps could be carried out simultaneously would be more advantageous from the standpoint of efficiency. In known methods, however, it was difficult to form the pressed portions that have identical predetermined shapes and uniform thicknesses because, generally speaking, the press member for forming a pressed portion and the cutting blade are made of metals that have a high rigidity and that are firmly assembled to each other so that if one or both of the portions has a fabrication error or assembling error, the formation of the pressed portion in the resulting article can be directly influenced by the error.

The present invention resides in providing a device and a method to form partially pressed portions that have a desired uniform thickness in the nonwoven fabric. The present invention is beneficial in that a blank material such as a nonwoven web can be pressed more uniformly despite variances in pressing and cutting portions of the converting machine. In the past, these variations may have caused the blank article to not be properly cut at all locations that were desired to be cut. The present invention provides a solution to these problems and enables pressing and cutting steps to be achieved contemporaneously without risk of leaving web portions uncut.

These and other advantages of the invention are more fully shown and described in the drawings and detailed description of this invention, where like reference numerals are used to represent similar parts. It is to be understood, however, that the drawings and description are for the purposes of illustration only and should not be read in a manner that would unduly limit the scope of this invention.

### BRIEF DESCRIPTION OF THE DRAWINGS

FIG. 1A is a schematic front view of a batch-type press machine 10 according to a first embodiment of the present invention;

FIG. 1B is a schematic front view of a continuous-type press machine 10′ according to another version of a first embodiment of the present invention;

FIG. 2A is a schematic sectional view of an upper plate 12 and a lower plate 14 of a press machine according to a first embodiment of the present invention;

FIG. 2B is a plan view of a cutting die 22 provided on an upper plate 12;

FIG. 3A is a sectional view showing an operation of a press member 26 in which a pressed portion having an uneven thickness is formed by non-uniformly configured press surfaces 27a, 27b;

FIG. 3B is a sectional view showing an operation of a press member 26 that forms a pressed portion that has a uniform thickness;

FIG. 4 is a sectional view of a die that has a press member 26 and an intermediate member 29, in a modified example of the present invention;

FIG. 5A is a sectional view, showing a step of placing a blank material 100 at a predetermined place in a press machine 10 according to a first embodiment of the present invention;

FIG. 5B is a sectional view, showing a step of moving an upper plate 12 and a lower plate 14 close to each other to form a pressed portion and cut configuration in a blank material 100;

FIG. 5C is a sectional view, showing a step of moving an upper plate 12 and a lower plate 14 in a direction away from one other to remove the pressed and cut article 102;

FIG. 6A is a plan view of a cutting die 122 for forming a modified shape of a pressed/cut article;

FIG. 6B is a sectional view of the cutting die 122 taken along the line A-A in FIG. 6A;

FIG. 6C is a front view of a cut/pressed article 104 that has been formed by the cutting die 122 of FIGS. 6A and 6B;

FIG. 7A is a plan view of a cutting die 222 for forming a pressed/cut acoustical insulation article 110;

FIG. 7B is a sectional view of the cutting die 222 taken along the line A-A in FIG. 7a;

FIG. 7C is a front view of an acoustical insulation article formed from the cutting die 222 of FIGS. 7A and 7B;

FIG. 8A is a sectional view of an upper plate 32 and a lower plate 34 of a press machine 30 according to a second embodiment;

FIG. 8B is a plan view of a pressing die 42 for upper plate 32 of FIG. 8A;

FIG. 9A is a sectional view, showing a step of placing a nonwoven fabric 300 at a predetermined place in a press machine 30 according to a second embodiment of the present invention;

FIG. 9B is a sectional view, showing a step of moving an upper plate 32 and a lower plate 34 close to each other to form a pressed portion 302 in the nonwoven fabric web;

FIG. 9C is a sectional view, showing a step of moving an upper plate 32 and a lower plate 34 in a direction away from one other to remove the resulting pressed article 300, 302;

FIG. 10 is a sectional view of a press member 12 and a support bed 14 wherein a press surface 427 and a support surface 421 have projections and depressions for creating an article that has similar-shaped projections and depressions.

### DETAILED DESCRIPTION OF PREFERRED EMBODIMENTS

In the practice of the present invention, a new apparatus is furnished which has first and second dies that are configured to move relative to each other. The first die has a general flat support surface for supporting a blank material, and the second die has a press surface for pressing the blank material, supported by the support surface, in an operation position in which the press surface faces the support surface. The forming device forms the pressed portion by pressing the press surface against the blank material. The invention is characterized in that the forming device comprises a gap adjusting means for equalizing a gap entirely between the support surface and the press surface when the press surface is in the operation position. The gap adjusting means has a support surface material that comprises a first hardness and that defines the support surface. The gap adjusting means also has a press surface material that comprises a second hardness and that defines the press surface. The second hardness is different from the first hardness.

The invention further provides a method for making a pressed portion partially in a blank material, characterized in that the method comprises (i) a step of providing a support surface defined by a support surface material having a first hardness, and a press surface defined by a press surface material having a second hardness, the second hardness being different from the first hardness. The method also includes (ii) a step of placing a blank material between the support surface and the press surface, (iii) a step of holding the blank material pressed between the support surface and the press surface by moving the support surface and the press surface close to each other, (iv) a step of forming a pressed portion by deforming at least one of the support surface and the press surface, equalizing a gap between the support surface and the press surface entirely, and pressing the blank material partially by the press surface.

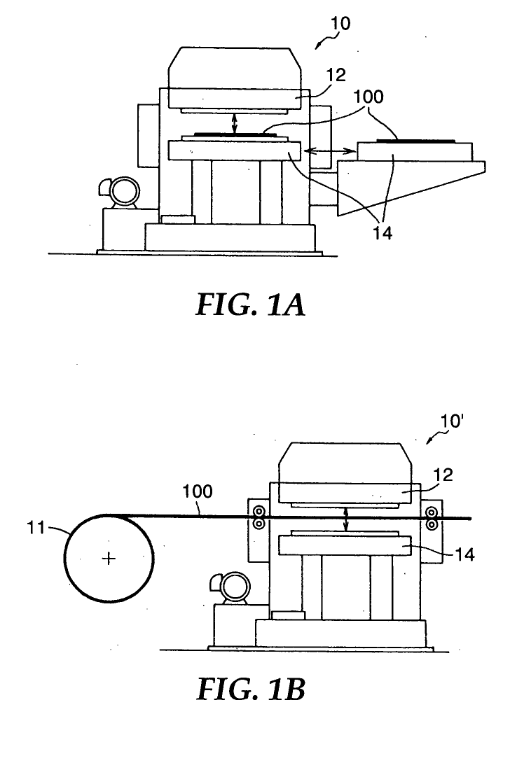

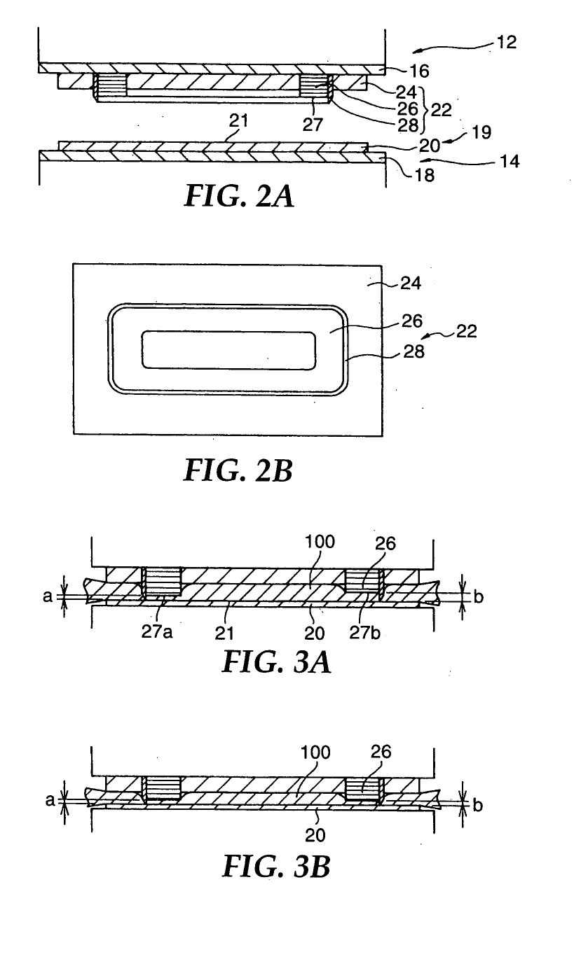

The present invention can be carried out using the press machines 10 and 10′ shown in FIGS. 1 and 2 where a blank material such as a nonwoven fabric, can be contemporaneously punched and pressed. In the device of FIG. 1A, a batch method is shown where placement and removal of the nonwoven fabric is manually carried out. In FIG. 1B, a continuous method is illustrated where the nonwoven fabric is fed from a nonwoven fabric roll 11. The press machine 10 or 10′ can be any kind of normally used press machine such as a hydraulic type, crank type, or the like. Both the batch machine 10 and the continuous machine 10′ have an upper plate 12 and a lower plate 14, which plates are capable of moving relative to each other and opposed to each other generally in parallel.

FIG. 2A shows that the press machine may further include heaters 16 and 18 that are capable of heating the upper plate 12 and the lower plate 14, respectively. The upper heater 16 heats a blade portion to contemporaneously heat and partially weld the cut portion of the nonwoven fabric. The heater 18 can be fashioned to heat the nonwoven fabric surface entirely to prevent the nonwoven fabric from fuzzing. The lower plate 14 has a first die 19, which die 19 has a support bed 20 with a substantially flat support surface 21 for supporting a nonwoven fabric. The upper plate 12 has a second or cutting die 22 for forming a pressed portion at a predetermined place in the nonwoven fabric and for cutting the nonwoven fabric into a predetermined shape. Alternatively, it is possible that the lower plate 14 has the cutting die 22 and the upper plate 12 has the first die with the support bed.

The blank article that is intended to be cut and pressed may comprise fibers that are united together as a nonwoven web that can be handable by itself as a unitary mat. If the article is intended to be used as an acoustical insulation, the web may include microfibers such as melt-blown microfibers, having an effective fiber diameter of about 1 to 50 micrometers (μm), more typically 2 to 30 μm, and often of about 3 to 10 or 15 μm. Such webs may also include staple fibers, such as crimped staple fibers as disclosed, for example, in U.S. Pat. No. 4,118,531 to Hauser; see also U.S. Pat. Nos. Re 36,323 and 5,841,081 to Thompson et al.

Melt-blown microfiber webs can be formed as described in Wente, Van A. “Superfine Thermoplastic Fibers” in Industrial Engineering Chemistry, vol. 48, pages 1342 et seq. (1956) or in Report No. 4364 of the Naval Research Laboratories, published May 25, 1954, entitled “Manufacture of Superfine Organic Fibers” by Wente, Van A., Boone, C. D., and Fluharty, E. L. The aspect ratio (ratio of length to diameter) of the melt-blown microfibers may approach infinity, although melt-blown microfibers are known to be discontinuous. The melt-blown microfibers can be formed from thermoplastic fiber-forming materials such as polyolefins, including, polyethylene, polypropylene or polybutylene, polyesters such as polyethylene terephthalate or polybutylene terephthalate, polyamides such as nylon 6 or nylon 66, polyurethane, or combinations thereof.

Webs of melt-blown microfibers also may contain staple fibers such as crimped bulking fibers, like those disclosed in U.S. Pat. No. 4,118,531 to Hauser. Crimped bulking fibers can have a continuous wavy, curly or jagged character along their length. The number of crimps per unit length can vary rather widely but generally is in the range of about 1 to about 10 crimps/cm, preferably at least about 2 crimps/cm. The size of the crimped bulking fiber can vary widely but generally is in the range of about 1 denier to about 100 denier, preferably about 3 to about 35 denier. Typically, the crimped bulking fibers have an average length of about 2 to about 15 cm, preferably about 7 to about 10 cm. The crimped bulking is fibers can be formed from polyesters, acrylics, polyolefins, polyamides, polyurethanes, rayons, acetates and mixtures thereof.

The webs also typically have a thickness of at least 5 centimeters, a density of less than about 50 kilograms per cubic meter, and a pressure drop of at least about 1 millimeter water at a flow rate of about 32 liters per minute.

As further shown in FIGS. 2A and 2B, the cutting die 22 may include a base 24 that is formed of a plate-like material such as a veneer. A press member 26 is provided on the base 24 and has a press surface 27 for pressing a predetermined portion of the nonwoven fabric to form a pressed portion in an operation position in which the press surface 27 is moved or juxtapositioned next to the support surface 21. A blade portion 28 of a predetermined shape may be provided on the base 24 to have a fixed lip that protrudes beyond the press surface 27. The blade portion 28 may be a band blade, generally known as a Thomson blade, and may be configured to cut and form the nonwoven fabric into a predetermined shape, including the pressed portion, in the operation step where the lip of the blade portion 28 abuts the support surface 21, as a result of movement of the upper plate 12 and the lower plate 14 toward each other. Also, as mentioned above, the blade portion 28 can form a heat seal at the cut portion of the nonwoven fabric as a result of heat transferred from the heater 16. The blade portion 28 may be removable from the base 24 so that it can be exchanged at an appropriate frequency. The press member 26 may be attached in the region of the base surrounded by the blade portion 28 and may be configured so that a predetermined portion of the nonwoven fabric (for example, a peripheral portion of the formed nonwoven fabric) is pressed by the press surface 27 to form a pressed portion of desired thickness, substantially at the same time as the cutting step. The press member 26 and the blade portion 28 can be secured to the base 24 using any suitable securing method, such as frictional or mechanical fitting, or bonding by an appropriate adhesive or weld.

In order to form the pressed portion in the nonwoven fabric, it may be desirable that the press member comprise a metal that has a high rigidity such as a carbon steel, which is frequently used in machine tools. If the press member, however, has a high rigidity, the formation of the pressed portion may be carried out easily, but it may be difficult to form a pressed portion that has a uniform thickness.

FIGS. 3A and 3B show a press machine that has a variance in the press surfaces 27a and 27b.

Depending on the fabrication accuracy of the press member 26, the press surface heights (generally noted as 27 in FIGS. 2A and 2B) on the base 24 of the cutting die 22 may not be uniform. If this happens, when the press machine reaches the operation position—namely, the position in which the Thomson blade of the cutting die cuts the nonwoven fabric—the higher press surface portion 27a of the press surface 27 presses the nonwoven fabric 100 relatively strongly, while the lower press surface portion 27b presses the nonwoven fabric relatively weakly (see FIG. 3A). In other words, when the press machine is in the operation position, a gap “a” between the press surface 27a and the support surface 21 is smaller than a gap “b” between the press surface 27b and the support surface 21 (FIG. 3A), thus resulting in uneven thickness of the pressed portion. Further, when the distance between the lip of the Thomson blade 28 and the press surface 27 is relatively small, a more serious problem may occur: the lip does not abut the support surface 21 around the portion pressed by the press surface 27b, causing that portion of the nonwoven fabric to remain uncut.

Because the press member and the support bed are generally both made from metals that have high rigidity, such as a carbon steel, and accordingly do not deform, the difference between the two gaps can be substantially maintained during the pressing operation. Accordingly, a gap adjusting means for equalizing the gap between the support surface and the press surface, when the press surface is in the operation position, is provided in accordance with this invention.

The gap adjusting means may include a support surface material of a first hardness and a press surface material of a second hardness different from the first hardness. In the press machine described with reference to FIGS. 3A and 3B, the support surface material that forms the support bed 20 having the support surface 21 is a material such as a metal, having the first hardness. The press surface material forming the press member 26 having the press surface 27 is a material such as plastic, having the second hardness, which is lower than the first hardness. With this structure, the above-mentioned problems with the cutting operation and the formation of the pressed portion can be eliminated. Even if the heights of the press surface 27a and the press surface 27b of the press surface 27 are different due to a relatively large tolerance of the dimension of the press member 26, the pressed portion of the nonwoven fabric may have a substantially uniform thickness. The reason for this is because, as shown in FIG. 3B, the press member 26 at the press surface portion 27a is appropriately deformed or elastically deformed by a reaction force produced when pressed against the support surface 21 through the nonwoven fabric (as the support surface 21 is harder than the press surface 27, the former is not substantially deformed), and, hence, the gap “b” between the press surface portion 27b and the support surface 21 is substantially equal to the gap “a” between the press surface portion 27a and the support surface 21, and consequently, the press surface portion 27b can strongly press the nonwoven fabric. Accordingly, even if the press member 26 is fabricated with a dimensional accuracy at which it cannot be expected that the pressed portion is formed uniformly, on the assumption that the press member is made of a metal having a rigidity as high as the material of the support bed 20, the pressed portion having a predetermined uniform thickness can be formed partially in the nonwoven fabric, thanks to the above-mentioned gap adjusting means.

Preferably, the hardness of the press member 26 is such that it can be easily machined into a predetermined shape and can be sufficiently deformed so as to form the pressed portion of uniform thickness. The material satisfying these requirements may have a Rockwell hardness measured by an ASTM (American Society for Testing and Materials) D785 test method and in the range of R80-R120. A plastic material, such as polypropylene, a vinyl chloride resin, a phenol resin, a silicon resin, or the like, having the above hardness may be used. Generally, these plastics have advantages such that they are less expensive than metal materials for machine tools, exhibit good machinability in laser cutting, and can be relatively easily machined into complicated shapes. From the viewpoint of manufacturing efficiency, the press member preferably is formed by laminated plastic plates as shown in the drawings. Alternatively, the press member 26 may be a metal such as aluminum or an alloy thereof.

The press member 26 also may be made of a metal such as a carbon steel. In this instance, instead of the press member, the support bed 20 may be made, at least at the portion pressed against the press surface 27, of a material having the above-mentioned Rockwell hardness measured by the ASTM D785 test method and in the range of R80-R120. Again, a plastic material such as polypropylene, a vinyl chloride resin, a phenol resin, a silicon resin, or the like, or a metal material such as aluminum or an alloy thereof having the hardness within the above range. In this case, the support surface 21 of the support bed 20 is appropriately deformed, instead of the press member, in a range that the entire lip of the blade portion abuts against the support surface 21, and thus, the pressed portion 102 having an uniform thickness can be formed in the nonwoven fabric 100.

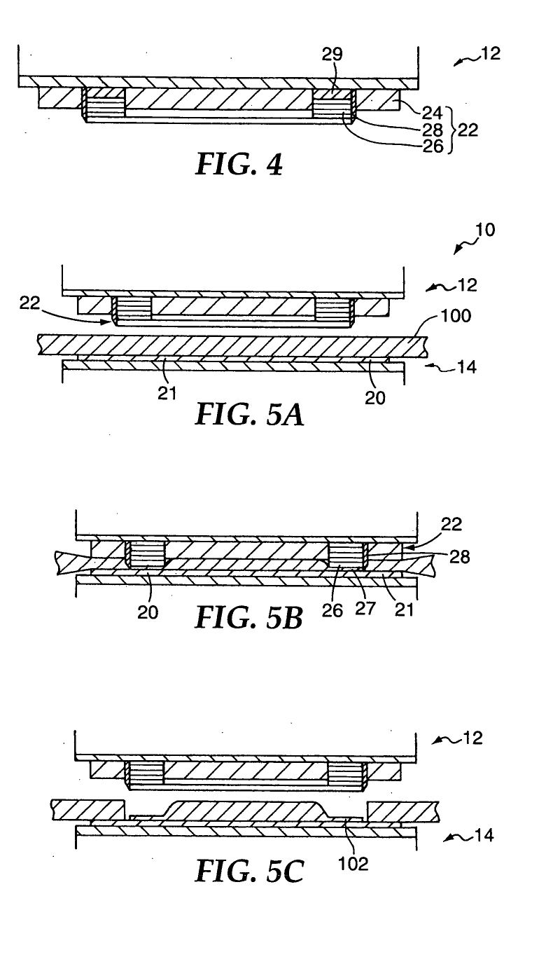

If the press member 26 is made, for example, of a metal, the cutting die 22 may have an intermediate member 29 that carries the press member 26 on the side opposite the nonwoven fabric (for example, in FIG. 4, provided between the heater 16 and the press member 26) and which has a lower hardness than the press member. As the intermediate member 29 is appropriately deformed in the operation position, the gap between the press surface 27 and the support surface 21 is entirely equalized and a uniformly thick pressed portion can be formed in the nonwoven fabric. In this case, because the hardness of the press surface is high, the formation of the pressed portion is made easier. As the intermediate member 29 does not abut against the nonwoven fabric, there is no lower limit to the hardness thereof. Accordingly, as the material of the intermediate member 29, a rubber material, a leaf spring having an appropriate spring modulus, can be used in addition to a plastic material like those cited above, as long as the press surface can form a uniformly thick pressed portion.

As the press machine 10 can carry out cutting of the blank material nonwoven fabric 100 (FIGS. 1A and 1B) and the formation of the pressed portion 102 (FIG. 5C) at one time, the invention has an advantage that the pressed portion can be formed with a high positioning accuracy, and the number of the manufacturing steps can be reduced, particularly when compared to the cutting and the forming the pressed portion separately. In practice, when the cutting and the formation of the pressed portion are carried out in different steps, the positioning accuracy of the pressed portion on the nonwoven fabric is low, that is, typically around ±5 mm, while the positioning accuracy of the pressed portion 102 on the nonwoven fabric 100 formed by the press machine 10 is typically within about ±2 mm.

As shown in FIGS. 5A-5C, the blank material 100 may be placed at a predetermined location between the support bed 20 and the cutting die 22 (FIG. 5A) of the press machine 10. The placement can be carried out by, for example, a batch method where the blank material 100 is manually placed on the support surface 21, or by a method in which the blank material 100 is fed from a roll as shown in FIG. 1B. The upper plate 12 and the lower plate 14 of the press machine 10 may then be moved towards each other to hold the blank material 100 therebetween under certain pressure. This operation is carried out until the blade portion 28 of the cutting die 22 abuts against the support surface 21 (FIG. 5B). At the occurrence of abutment, at least a part of the press member 26 (or the support bed 20) deforms to equalize the gap between the press surface 27 and support surface 21. Consequently, a predetermined portion of the blank material 100 is locally pressed to form a pressed portion 102 having a desired uniform thickness, and the blade portion 28 cuts the blank material 100 into a predetermined shape. Preferably, in order to certainly obtain the desired pressed portion, the abutment—that is, the state that the press surface 27 presses the blank material 100—is maintained for about 1 to 3 seconds. The upper plate 12 and the lower plate 14 may then be moved in a direction away from each other (FIG. 5C), so that the cut and pressed article 102 can be removed.

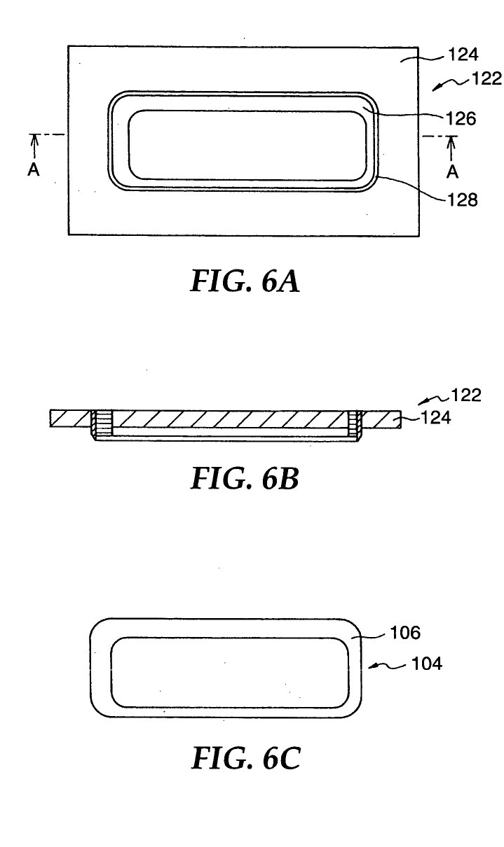

The arrangement of the press member and the blade portion on the base can be modified in accordance with a required shape of the cut and pressed article. FIGS. 6A and 6B, for example, show a cutting die 122 for making an article 104 that has a pressed portion whose width varies (FIG. 6C). As shown in FIGS. 6A and 6B, the width of the press member 126 may vary depending on the width of the pressed portion 106 that is intended to be formed on the nonwoven fabric 104.

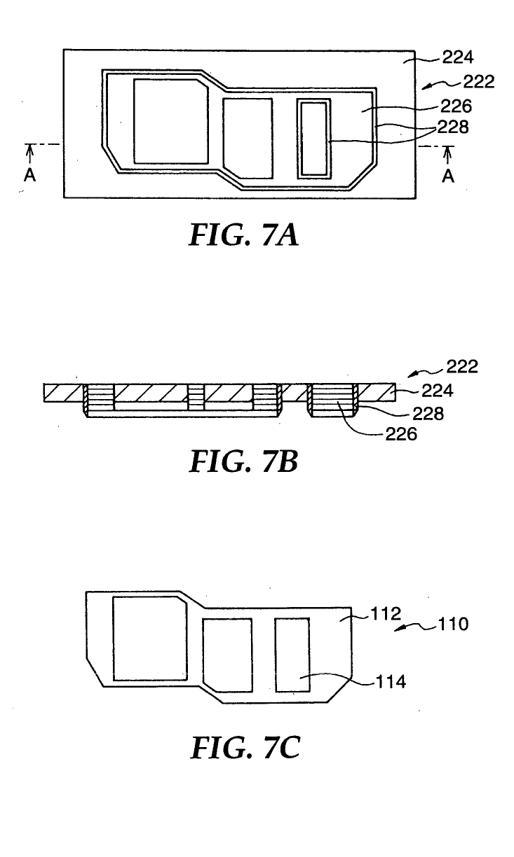

Depending on the arrangement of the press member and the blade portion, various pressed/cut articles can be formed. FIGS. 7A and 7B show, for example, a cutting die 222 that can be used to fashion a pressed/cut nonwoven acoustical insulation article 110 (FIG. 7C) that can be used as an acoustical insulation in an automobile. Such a pressed/cut article 110 can be attached to a fender liner applied to a wheel house to reduce a noise caused by a splash of water during movement of a vehicle. Other articles may be configured for placement within a motor vehicle door. Blade portions 228 are shown in FIG. 7B to extend from a base 224, which corresponds to the contour of the nonwoven fabric 110 and a hole 114. A press member 226 can be located to correspond with a pressed portion 112 that is intended to be formed on the nonwoven fabric 110. In alternative embodiments, the nonwoven fabric may be used as an acoustic insulation material for a bonnet hood of a vehicle, various ducts, a door panel, a ceiling material, an instrument panel, a trunk, a pillar, and the like.

Although a device and a method for making a pressed/cut nonwoven fabric has been explained above, it is, of course, possible to carry out the cutting and the formation of the pressed portion in different steps. In this instance, the number of steps is increased, but it may sometimes be more convenient to separate the cutting from pressing in, for example, small lot production.

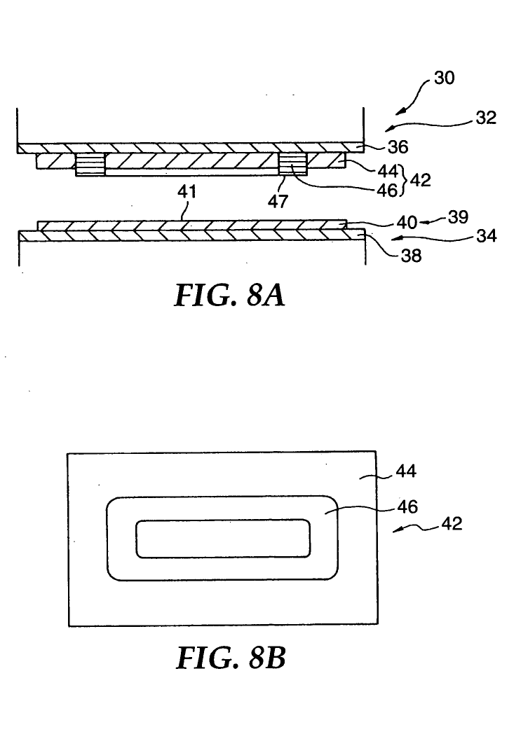

As illustrated in FIG. 8A, a press machine 30 according to another embodiment of the present invention may be used.

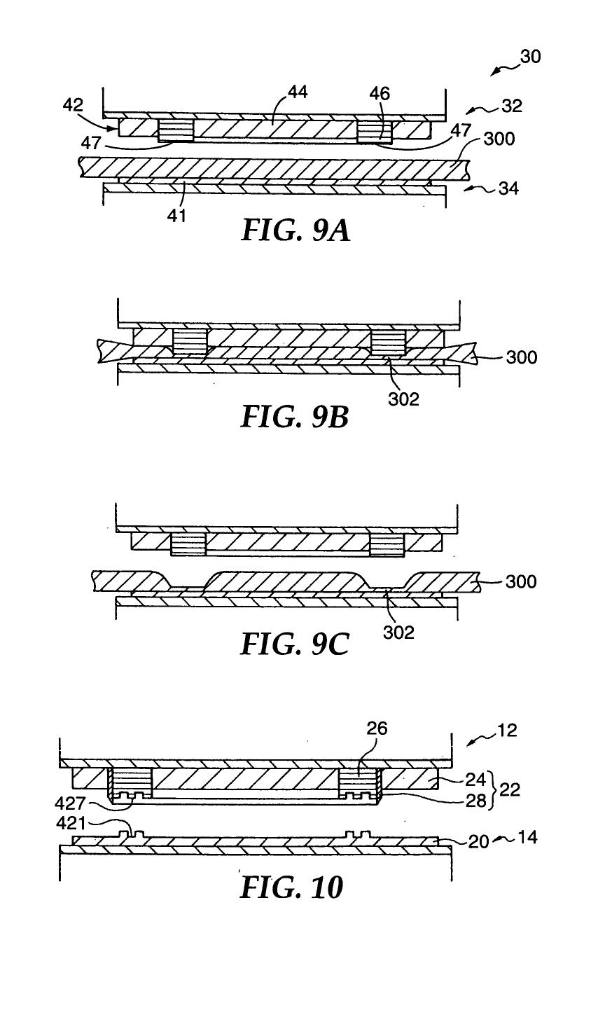

The press machine 30 is similar to the press machine 10 in FIGS. 1A and 1B, except that the die has no blade portion. The press machine 30 can be any kind of normally used press machine such as a hydraulic type, a crank type, etc., and can have an upper and lower plates 32 and 34, respectively, which plates are capable of moving relative to each other and opposed to each other generally in parallel (see FIG. 8A). The press machine 30 may further comprise heating means 36 and 38, such as heaters, capable of heating the upper plate 32 and the lower plate 34, respectively. Heating may reduce surface fuzzing. The lower plate 34 can be provided with a first die 39 that has a support bed 40, with a substantially flat support surface 41 for supporting, for example, a nonwoven fabric 300 (FIG. 9A) to be punched. The upper plate 32 can be provided with a second or pressing die 42 for forming a pressed portion 302 (FIG. 9C) at a predetermined place in the nonwoven fabric 300. Alternatively, the lower plate 34 may have a pressing die 42, and the upper plate 32 may have the first die 39 having the support bed 40.

As shown in FIGS. 8A and 8B, the die 42 may comprise a base 44 formed by a plate-like material such as a veneer, and a press member 46 provided on the base 24 and having a press surface 47 for pressing a predetermined portion of a nonwoven fabric 300 to form a pressed portion 302 (FIG. 9C). The press member 46 can be configured so that a predetermined portion of the nonwoven fabric 300 (FIG. 9A) (for example, a peripheral portion of the formed nonwoven fabric) is pressed by the press surface 47 to form a pressed portion 302 having a desired thickness, substantially at the same time as the press machine 30 reaches the operation position. The press member 46 can be secured to the base 44 by any conventional securing method, such as fitting, or bonding by an appropriate adhesive.

The press machine 30 has a gap adjusting means as in the press machine 10. A support surface material for forming the support bed 40, having the support surface is a material, such as a metal, having a first hardness, and a press surface material for forming the press member 46 having the press surface 47 is a material, such as plastic, having a second hardness, that is lower than the first hardness. The pressed portion 302 (FIG. 9C) can have a desired uniform thickness and can be formed partially in the nonwoven fabric 300. The reason is the same as that explained for the press machine 10 with reference to FIGS. 3A and 3B.

The nonwoven fabric having the pressed portion formed therein is cut or cut and formed in advance into a predetermined shape in a separate step. Conversely, after the pressed portion is formed, cutting or cutting and forming into a predetermined shape can be carried out in a separate step.

The hardness of the material having the second hardness of which the press member 46 is made can be similar to the material for forming the press member 26 of the press machine 10, and can be such that it can be easily machined into a predetermined shape and can be sufficiently deformed to form the pressed portion 302 having a uniform thickness in the nonwoven fabric 300. Materials satisfying these requirements preferably has Rockwell hardness as indicated above. Materials similar to the plastics described above may also be used. If the hardness is in the above-mentioned range, the press member 46 may be a metal such as aluminum or an alloy thereof.

The press member 46 may alternatively be made of a metal such as a carbon steel. In this instance, instead of the press member, the support bed 40 may be made, at least at the portion pressed against the press surface 47, of a material having the above-mentioned Rockwell hardness. In this case, the support surface 41 of the support bed 40 is appropriately deformed, instead of the press member.

Alternatively, if the press member 46 is made of a metal, similar to the cutting die 22 of the press machine 10, the die 42 may have an intermediate member 49 (not shown) that is substantially the same as the intermediate member 29, which carries the press member 46 on the side opposite the nonwoven fabric 300 and which has a lower hardness than the press member 46. As the intermediate member 49 is appropriately deformed in the operation position, the gap between the press surface 47 and the support surface 41 is entirely equalized and the pressed portion having an uniform thickness can be formed in the nonwoven fabric. As the material of the intermediate member 49, a rubber material, a leaf spring having an appropriate spring modulus, etc., can be used in addition to a plastic material such as polypropylene, a vinyl chloride resin, a phenol resin, a silicon resin, or the like, or a metal material such as aluminum or an alloy thereof, as long as the press surface can form the pressed portion having an uniform thickness in the nonwoven fabric.

FIGS. 9A-9C illustrate a method for forming the pressed portion in the nonwoven fabric using a press machine 30.

A blank material such as a nonwoven fabric 300 is placed at a predetermined place between the support bed 40 and the pressing die 42 (FIG. 9A), of the press machine 30. The placement can be carried out by, for example, a method where the nonwoven fabric 300 is manually placed on the support surface 41, or by a method in which the nonwoven fabric is fed from a roll of nonwoven fabric by a feeding roll as shown in FIG. 1. The upper plate 32 and the lower plate 34 of the press machine 30 are then moved close to each other to hold the nonwoven fabric 300 therebetween under a pressure. This operation is carried out until the press surface 47 of the press member 46, having the pressing die 42, presses the nonwoven fabric 300 to form the pressed portion 302 at a predetermined place in the nonwoven fabric 300 (FIG. 9B) At least a part of the press member 46 (or the support bed 40) deforms to equalize the gap between the press surface 47 and support surface 41 entirely. Consequently, a predetermined portion of the nonwoven fabric 300 is locally pressed to form a pressed portion 302 (FIG. 9B) having a desired uniform thickness. Preferably, in order to obtain the desired pressed portion, the abutment—that is, the state that the press surface 47 presses the nonwoven fabric 300—is maintained for 1 to 3 seconds. The upper plate 32 and the lower plate 44 are moved in a direction away from each other (FIG. 9C), so that pressed nonwoven fabric 302 can be removed.

As mentioned above, the nonwoven fabric 300 having the pressed portion 302 formed therein may be previously cut or punched into a predetermined shape in a separate step, or the cutting or punching may be carried out after the pressed portion is formed.

In the press machines described above, the press surfaces and of the press members, and the support surfaces of the support beds are all illustrated as being flat surfaces. As shown in FIG. 10, irregular support and press surfaces may also be used. A support surface 421 and/or a press surface 427 that have projections and depressions as shown in FIG. 10 may be used to product an irregularly pressed article. In this case, the press surface 427 and the support surface 421 may generally have complementary shapes. The resulting article will have an uneven structure, which may be advantageously used for mounting the article in an area between a noise source and a sound attenuated area, for example, in the door of an automobile.

Using a device and a forming method using the device according to the present invention, even though a fabrication error of the press member may be relatively large, a pressed article can be easily obtained. Further, by providing a blade to the die, cutting and formation of the pressed portion can be carried out at one time, and a nonwoven fabric having a pressed portion with a high positioning accuracy can be achieved.

This invention may take on various modifications and alterations without departing from the spirit and scope thereof. Accordingly, it is to be understood that this invention is not to be limited to the above-described, but it is to be controlled by the limitations set forth in the following claims and any equivalents thereof.

It is also to be understood that this invention may be suitably practiced in the absence of any element not specifically disclosed herein.

All patents and patent applications cited above, including those in the Background section, are incorporated by reference into this document in total.

1. An apparatus for making pressed nonwoven articles, which apparatus comprises:
first and second die members that are arranged to move towards each other, the first die having a support surface for supporting a blank material, and the second die having a press surface for pressing the blank material when the two dies are disposed in an operation position;
the support surface comprising a support surface material that has a first hardness, and the press surface comprising a press surface material that has a second hardness, the first and second hardnesses being different from each other.

2. The apparatus of claim 1, wherein the first and second harnesses are different at least at the location where the blank material is intended to be pressed between the first and second dies.

3. The apparatus of claim 1, wherein the first die comprises a support bed having the support surface, the support bed being formed by the support surface material; the second die comprises a press member having the press surface, the press member being formed by the press surface material.

4. The apparatus of claim 1, wherein the first die comprises a support bed having the support surface, the support bed being formed by the support surface material; the second die comprises a press member having the press surface, and an intermediate member carrying the press member, the intermediate member being formed by the press surface material.

5. The apparatus of claim 1, wherein one of the support surface material and the press surface material is metal, and the other is plastic having a lower hardness than that of the metal.

6. The apparatus of claim 5, wherein Rockwell hardness of the plastic measured by ASTM D785 test method is in the range of R80-R120.

7. The apparatus of claim 1, wherein the second die further comprises a blade portion having a fixed lip protruding beyond the press surface, the lip of the blade portion being configured to cut and form the blank material supported by the support surface, when the press surface is in the operation position, such that the blank material includes the pressed portion.

8. A method for making a pressed portion partially in a blank material, which method comprises:
providing a support surface that has a first hardness, and a press surface that has a second hardness, the second hardness being different from the first hardness;
placing a blank material between the support surface and the press surface; and
pressing the blank material between the support surface and the press surface by moving the support surface and the press surface towards each other such that at least one of the support and press surfaces is capable of equalizing a gap therebetween.

9. The method of claim 8, further comprising a step of cutting the blank material through use of a blade portion, the cutting step occurring essentially contemporaneously with the pressing step.

10. The method of claim 8, wherein the blank material is a nonwoven fibrous web.

11. The method of claim 9, wherein the blank material is a nonwoven fibrous web.

12. The method of claim 8, wherein at least one of the press surface or support surface is made of metal, the other surface being made from plastic.

13. The method of claim 10, wherein the nonwoven fibrous web comprises meltblown microfibers.

14. The method of claim 13, wherein the nonwoven fibrous web also contains crimped bulking fibers.

15. A method of making an acoustical insulation, which method comprises:
(i) providing first and second surfaces that have first and second different hardnesses, respectively;
(ii) placing a nonwoven fibrous web between the first and second surfaces; and
(iii) pressing the nonwoven fibrous web to create reduced thickness portions in the web.

16. The method of claim 15, further comprising (iv) cutting the nonwoven web to an intended configuration.

17. The method of claim 16, wherein the cutting and pressing steps occur essentially contemporaneously.

18. The method of claim 16, wherein the nonwoven fibrous web comprises microfibers and crimped bulking fibers.

19. The method of claim 15, wherein the nonwoven fibrous web contains microfibers that have an effective fiber diameter of less than about 30 micrometers that have a density of less than about 50 kg/m³, and that exhibit a pressure drop of at least about 1 mm H₂O at a flow rate of 32 liters per minute.
